(19) United States
(12) Patent Application Publication
(10) Pub. No.: US 2015/0052159 A1
(43) Pub. Date: Feb. 19, 2015

(54) FILE NAME DISPLAY METHOD AND SYSTEM, AND COMPUTER STORAGE MEDIUM

(71) Applicant: TENCENT TECHNOLOGY (SHENZHEN) COMPANY LIMITED, Shenzhen, Guangdong (CN)

(72) Inventors: Gang Liu, Shenzhen (CN); Yunsheng Wu, Shenzhen (CN)

(21) Appl. No.: 14/386,125

(22) PCT Filed: Jan. 25, 2013
(86) PCT No.: PCT/CN2013/070983

§ 371 Date: Sep. 18, 2014

(30) Foreign Application Priority Data
Mar. 22, 2012 (CN) 201210079245.9

(51) Int. Cl. G06F 17/30

(52) U.S. Cl. CPC G06F 17/30123; G06F 17/30106
USPC 707/754; 707/756

(57) ABSTRACT

The present invention relates to a method and system for displaying the file name as well as a computer storage medium, the method includes the following steps: receiving a check request for a file, the check request comprising display dimension of a terminal; searching file name information corresponding to the display dimension of the terminal in a pre-established correspondence relationship between display dimensions of terminals and file name information; and returning the file name information searched out to the terminal and displaying the file name information searched out on the terminal. According to the above method, system and computer storage medium, the correspondence relationship between terminals' display dimensions and file name information is established in advance, the corresponding file name information is found according to the obtained display dimension of the terminal and is returned and displayed on the terminal, so that it can be realized that the file name information with a fit length to be displayed on the terminal is found through matching according to various display dimensions of the terminals, and it is convenient for the user to check the file name information.

### CROSS-REFERENCE TO RELATED APPLICATIONS

This application is a U.S. National Phase Application under 35 U.S.C. 371 of International Application No. PCT/CN2013/070983 filed on Jan. 25, 2013 and published in Chinese as WO/2013/139185 on Sep. 26, 2013. This application is based on and claims the benefit of priority from Chinese Patent Application No. 2012-10079245.9 filed on Mar. 22, 2012. The entire disclosures of all of the above applications are incorporated herein by reference.

### TECHNICAL FIELD

The present invention relates to a field of data processing, and in particular to a method and system for displaying a file name and a computer storage medium thereof.

### BACKGROUND

Along with development of Internet technology, a user at any place is able to access various kinds of data in a server in the cloud through a terminal, and to apply and share data resources of the server in the cloud at any time. When different terminals are displaying contents, they usually use a files name to represent a corresponding file. To distinguish different files, each file is named with a file name. Accordingly, the files in the server distinguish each other through their respective file names.

The file name is an identifier of the file. An operating system controls and manages the file according to its file name. Different operating systems are slightly different in file naming rules, that is, they are different in the format and length of the file name. For example, the DOS operating system prescribes that the file name consists of a main file name and an extension name, the main file name includes one to eight characters, the extension name includes one to three characters, and the main file name and the extension name are separated by a dot. The Windows system permits a long file name, and its file naming rule is mainly as follows: the file name includes up to 255 characters, the extension name may be used to represent a file type, extension names with multiple separators may be adopted, e.g., win.ini.txt, in which the file type is represented by the last extension name, and a blank space is permitted to be included in the file name while characters such as “Λ”, “:”, “*”, “?” and so on are not permitted. In addition, in the Windows system, the file name is case sensitive in its display but is not case sensitive in its usage.

Some terminals usually display a part of a long file name of a file and the other part of the long file name is displayed as suspension points, so it is difficult for a user to recognize useful information. In this case, the user has to modify or organize the file name manually, or after the file with the long file name is retrieved and saved in local, to rename a batch of files via a third-party tool to shorten the length of the file name for the convenience of display and recognition. However, the above method needs the user's manual operation to modify the file name, and it is inconvenient to check the file name.

### SUMMARY

A method for displaying a file name is provided, and the method includes the following steps:

receiving a check request for a file, the check request including display dimension of a terminal;

searching file name information corresponding to the display dimension of the terminal in a pre-established correspondence relationship between display dimensions of terminals and file name information; and

returning the file name information searched out to the terminal and displaying the file name information searched out on the terminal; and

the method further includes a step of pre-establishing the correspondence relationship between display dimensions of terminals and file name information;

the step of pre-establishing the correspondence relationship between display dimensions of terminals and file name information comprises steps of:

obtaining a string of an original file name;

obtaining keyword information by matching the string of the original file name with a pre-established keyword information library;

retrieving a file name from the string of the original file name according to a regular expression rule;

combining the file name retrieved and the keyword information to form file name information with various lengths; and

establishing the correspondence relationship between the display dimensions of the terminals and the file name information with various lengths.

In addition, a system for displaying a file name is provided, the system includes:

a file name database, adapted to store a pre-established correspondence relationship between display dimensions of terminals and file name information; and

an interface server, including:
a receiving module, adapted to receive a check request for a file, the check request including the display dimension of a terminal; a
a search module, adapted to search the file name information corresponding to the display dimension of the terminal in the pre-established correspondence relationship between the display dimensions of terminals and file name information stored in the file name database; and
a returning module, adapted to return the file name information searched out to the terminal and display the file name information searched out on the terminal; and
the system further includes:

a file name material library, adapted to store the string of the original file name;

a keyword information library, adapted to store keywords; and

a file name retrieving server, including:
a match module, adapted to obtain keyword information by matching the string of the original file name with the keyword information library;
a retrieving module, adapted to retrieve a file name from the string of the original file name according to a regular expression rule;
a combination module, adapted to combine the file name retrieved and the keyword information to form file name information with various lengths; and
a relationship establishment module, adapted to establish the correspondence relationship between the display dimensions of the terminals and the file name information with various lengths, and store the correspondence relationship in the file name database.

Furthermore, one or more computer storage mediums including computer-executable instructions are provided, the computer-executable instructions are adapted to perform the above-mentioned method for displaying a file name.

### BRIEF DESCRIPTION OF DRAWINGS

FIG. 1 is a flow chart of a method for displaying a file name in an embodiment.

FIG. 2 is a flow chart for establishing correspondence relationship between terminals' display dimensions and file name information.

FIG. 3 is a diagram illustrating an internal structure of a system for displaying a file name in an embodiment.

FIG. 4 is a diagram illustrating an internal structure of a system for displaying a file name in another embodiment.

FIG. 5 is diagram illustrating an internal structure of a server for retrieving a file name in an embodiment.

### EMBODIMENTS

Technical schemes will be described in detail in reference to specific embodiments and accompanying drawings hereinafter.

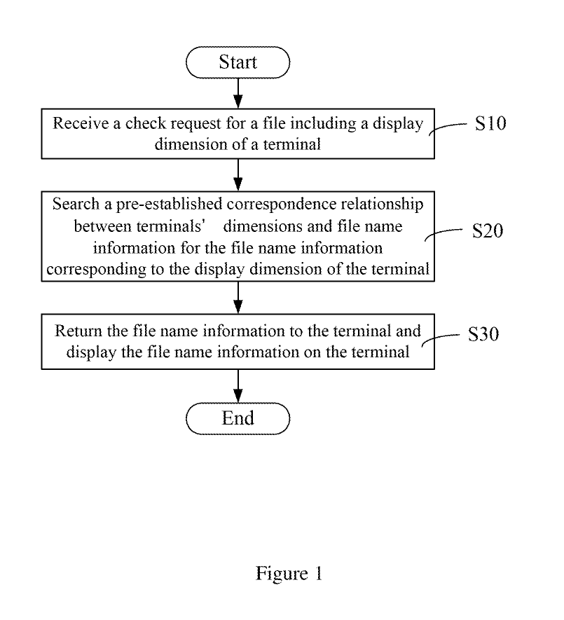

As shown in FIG. 1, a method for displaying a file name in an embodiment includes steps as follows:

In Step S10, a check request for a file is received, and the check request includes a display dimension of a terminal.

Specifically, the display dimension of the terminal is referred to as the dimension of a User Interface (UI) of the terminal which mainly includes the height and the width of a display area. The terminal may be various devices required to display the file name, such as a portable media player, a desktop computer, a laptop computer, a PDA, a cell phone and etc.

In Step S20, file name information corresponding to the display dimension of the terminal is found by matching the display dimension of the terminal with a pre-established correspondence relationship between terminals' display dimensions and file name information.

Specifically, the pre-established correspondence relationship between terminals' display dimensions and file name information may be stored in a file name database, and the corresponding file name information may be obtained by searching the file name database according to the received display dimension of the terminal.

In Step S30, the file name information is returned to the terminal and is displayed on the terminal.

Specifically, the file name information obtained is returned to the terminal and displayed on the terminal. As the file name information is obtained according to the display dimension of the terminal, the file name information can be completely displayed on the terminal.

In an embodiment, the method for displaying the file name may further include a step of pre-establishing a correspondence relationship between terminals' display dimensions and file name information.

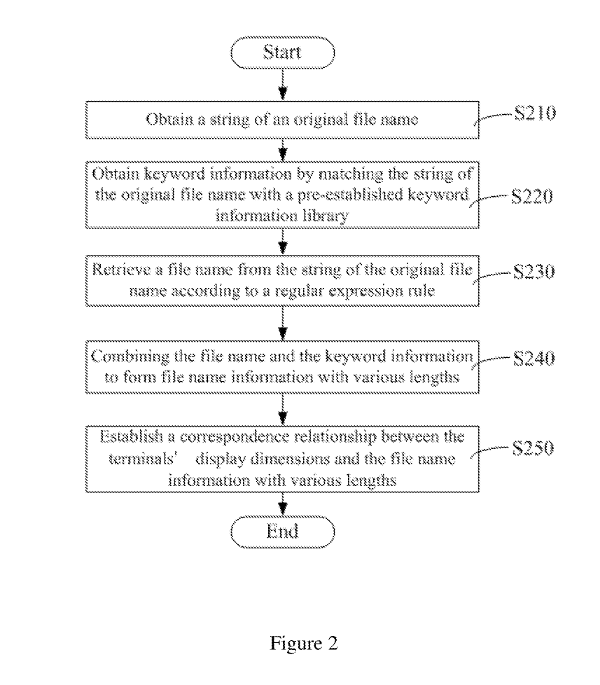

As shown in FIG. 2, the step of pre-establishing a correspondence relationship between terminals' display dimensions and file name information includes the following:

In Step S210, a string of an original file name is obtained.

In the embodiment, the file name of a file is mainly referred to as the file name of a multi-media file, and the string of the original file name of a multi-media file is obtained. The multi-media file may include files such as a movie, a TV play, a news video, a self-shot video and etc. The multi-media file may generally be an online video retrieved from a popular video website.

The string of the original file name is referred to as complete file name information. Taking a movie's file name information as an example, the file name information of the movie includes a movie title, file release source information, release version information, audio/video coding information, file format information, definition information and etc., such as “Captain.America.The.First.Avenger.2011.AmericanCaptain.BilingualSubtitle.HR-HDTV.AC3. 1024×576.×264-RenrenMovie&TVProduction.mkv”, where “Captain.America.The.First.Avenger” denotes the movie title, “2011” denotes the decade, “AmericanCaptain” denotes the Chinese title, “BilingualSubtitle” denotes the type of subtitles, “HR-HDTV” denotes the compression format, “AC3” denotes the audio format, “1024×576” denotes the resolution, “×264” denotes the compression technique, “RenrenMovie&TVProduction” denotes the producer, and “mkv” denotes the file format.

Taking a TV play's file name information as an example, the file name information of the TV play includes a paly title, a season number, an episode number, a signal acquisition source, audio/video coding, a production group and etc., such as “Prison.Break.S02E01.Manhunt.HR.HDTV.AC3.5.1.XviD-DiMENSION”, where “Prison.Break” denotes the play title, “S02” denotes the season number, “E01” denotes the episode number, “Manhunt” denotes the episode name, “HDTV” denotes the signal acquisition source, “AC3.5.1” denotes the audio coding, “XviD” denotes the video coding, and “DIMENSION” denotes the production group.

In Step S220, the string of the original file name is matched with a pre-established keyword information library to obtain keyword information.

In the embodiment, the keyword information library may be established in advance which stores keywords and includes but not limited to a file publishing source dictionary library, a file format source dictionary library, a video and audio encoding format dictionary library, a release version dictionary library and a definition dictionary library.

The keyword include a file publishing source keyword, a file format source keyword, a video and audio encoding format keyword, a release version keyword and a definition keyword etc.

The file publishing source dictionary library specifically includes but not limited to contents as follows: CAM, TS, TC, DVDSCR, DVDRIP, HR-HDTV, HDRIP, BDRIP, REMUX, R5, Mini SD and etc., where CAM usually denotes the file recorded at the cinema by a digital video recorder; the standard of TS is the same as CAM while TS denotes the file recorded using an external sound source and the image quality of TS may be better than that of CAM; TC denotes the file of a digital copy of a film, the image quality of TC is quiet good, much better than that of TS, but it lacks brightness, its image is quiet dark and its audio quality is too bad; DVDSCR denotes the file which is obtained from a preview version DVD file and compressed with high quality via MPEP-4; DVDRIP denotes the conversion from a final version DVD file in which the DVD video, audio and subtitles have been stripped from the parent file, and then compressed to form a multi-media file consists of an audio/video file with a suffix of “.avi” and a subtitle file; HR-HDTV denotes the file with better image definition which is obtained by performing high-quality compression on an HDTV video image via MPEG4 compression techniques such as Div X/XviD/×264 etc., then encapsulating the part of video and audio data into a file with a suffix of “.avi” or “.mkv”, and adding an add-on subtitle file; HDRIP denotes the high-definition conversion from an HD-DVD file, the image quality of which is better than an ordinary high-definition conversion; BDRIP (Blue-ray Disc Rip) has better image quality than HDRIP; REMUX denotes the file which is obtained by retrieving video and audio data of HD-DVD and BluRay-DVD without loss, then encapsulating the video and audio data in to a TS or AVI file to compress and recode the original high-definition data; R5 denotes a Russian No. 5 District version; and, Mini SD denotes a standard definition production standard issued by the TLF group which prescribes the horizontal resolution is 800˜860 and is a more advanced video/audio production standard of ×264 coding.

The file format source dictionary library includes but not limited to movie file format keywords such as RMVB (Variable Bit Rate), FLU (Flash Video), AVI (Audio Video Interleaved), MKV, MOV, MP4, TS and etc., where MKV denotes a file integrating multiple types of audio tracks and subtitle tracks, the video coding of which is various, and it may be the file of DivX, XviD or 3IVX, or even a streaming video such as RealVideo, QuickTime or WMV; MOV denotes the file in the video format of QuickTime which is an audio/video file format developed by Apple Co. adapted to store normal digital media types; MP4 denotes the file format adopting MPEG-4 video compression coding; and TS denotes the high-definition format with a file suffix of “TS”.

The video and audio encoding format dictionary library records video coding formats include but not limited to XviD, AC3, DD5.1 and etc., where XviD is a normal video compression coding format of MPEG-4; ×264 is a free video compression coding format of H.264/MPEG-4 AVC which adopts H.264 standard; and according to DD5.1, 5.1 sound track is a music playing method using 5 speakers and one subwoofer.

The release version dictionary library records video release version keywords such as versions of Director's Cut, Unrated, LIMITED, Extended, REPACK, IMAX (Image Maximum) and etc., where REPACK denotes the version which is released to solve problems if the release group releases a bad version.

The definition dictionary library records video definition keywords such as 720P, 1080I, 1080P and etc., where 720P, 1080I and 1080P are the highest-level format standards of high-definition digital TV constituted by U.S. Movie/TV Engineers (SMPTE); 720P denotes a display format with the resolution of 1280×720 obtained by progressive scanning which is the lowest standard of high-definition video; 1080I denotes a display format with the resolution of 1920×1080 obtained by interlaced scan on 1080 lines, the level of which is just next to 1080P; and 1080P is the highest-level format standards of high-definition digital TV, and its valid display format is 1920×1080.

A string-based matching method may be adopted in matching the string of the original file name with the keyword information library. Specifically, the matching is performed for the string of the original file name according to a maximum matching method. For example, the longest entry in the keyword information library has i characters, the first i characters in an array of the string of the original file name to be matched is taken as a match field to be matched in the keyword information library; if there is a word with i characters in the keyword information library, it indicates a successful match, and then the match field is split from the string of the original file name as a word, and otherwise, if there is no such word with i characters in the keyword information library, it indicates a unsuccessful match, and then the last character of the match field is removed, the match word including remaining characters is used to be matched in the keyword information library again; the matching process is repeated as above until a successful match is got.

In an embodiment, before Step S220, the method further includes a step of filtering out useless characters in the string of the original file name in order to remove from the original file name useless characters which have strong regularity. The useless characters mainly include the following three types:

(i) The first type of useless characters denotes a multi-media file is which part of a TV play, such as the second chapter of the seventh episode, the eighth dialog, the seventh scene, part A, part1, cd1, cd2, the first part, the last part and etc.

(ii) The second type of useless characters denotes some common description words including stop words or functional words, such as a Mandarin version, a Cantonese version, Chinese subtitles, an U.S. play, a Korean play, classics, hit, a love-story play, animation, horror, action, romance, comedy, long trailers, trailers, stories behind the scenes, stories and etc.

(iii) The third type of useless characters denotes meaningless characters or junk information such as a large number of certain junk fields e.g., premiere, exclusive premiere, the latest, watch online, the first exclusive online premiere, summer must-see, dubbing, TV and TV play as well as some junk characters and those with no content like ] [, [“&&”], “ [symbol] “&&” [symbol] ”, ( ), ( ), [ ] and etc.

In Step S230, the file name is retrieved from the string of the original file name according to a regular expression rule.

Specifically, a regular expression is referred to as a single string for describing or matching with a series of strings in accordance with a certain syntactic rule. Through retrieving the file name according to the regular expression rule, a part of the string of the original file name which is matched with the regular expression rule can be replaced by a predefined character such as a blank space, an underscore or etc. An example of the regular expression rule is as shown in Table 1.

TABLE 1

| | The example of the regular expression |
|---|---|
| Number | rule |
| 1 | No.?[0-9 zero one two three four five six |
| | seven eight nine ten hundred |
| | thousand] + [part dialog episode chapter |
| | season section scene]([first middle last |
| | a-z])? |
| 2 | No. [0-9 zero one two three four five six |
| | seven eight nine ten hundred]+ |
| 3 | part. ?([a-z][I][II]\| ([0-9]+)) |
| 4 | (S\|E\|Season\|Episode\|CD).?[0-9]+ |
| 5 | [\[\] [symbol] [symbol] ( )( ) <> [symbol] [symbol] \-_. ][ first middle last |
| | a-z]([\[\] [symbol] [symbol] ( )( )<> [symbol] [symbol] \-_. ]\|$) |
| 6 | [\[\] [symbol] [symbol] ( )( )<> [symbol] [symbol] \-_. ][zero one two three |
| | four five six seven eight nine ten |
| | hundred./0-9-]+([\[\] [symbol] [symbol] ( )( )<> [symbol] [symbol] \-_. ]\|$) |
| 7 | [\hat{ }a-z][a-z]$ |
| 8 | [/0-9\[\] [symbol] [symbol] ( )( )<> [symbol] [symbol] \-_.]+$ |

In Table 1, if there is a character in accordance with the regular expression rule in the string of the original file name, the character is replaced by the predefined character, e.g., the character “( )” is replaced by the underscore. For example, “Life-threatening Surgery_cd1.part.1” is finally replaced by “Life-threatening Surgery ______”, and after filtering out the useless characters such as the blank space and underscore etc., the field “Life-threatening Surgery” can be retrieved according to the regular expression rule.

In Step S240, the file name information of a different length is formed by combining the file name and the keyword information.

Specifically, any combination of the file name and the keyword information may form the file name information. For example, a piece of file name information may be formed by any combination of source codes, the mkv format and a resolution of 1024×576.

In Step S250, the correspondence relationship between the terminal's display dimension and the file name information is established.

Specifically, the file name information with a different length may be matched with the terminal's display dimension, the pre-established correspondence relationship between the terminal's display dimension and the file name information can guarantee that the whole file name information can be displayed on the terminal.

In an embodiment, the method for displaying the file name further includes a step of receiving a check request for the complete file name information of a file and returning the complete file name information of the file to the terminal. When the user needs to check the complete file name information of the file, the server returns the complete file name information to the terminal.

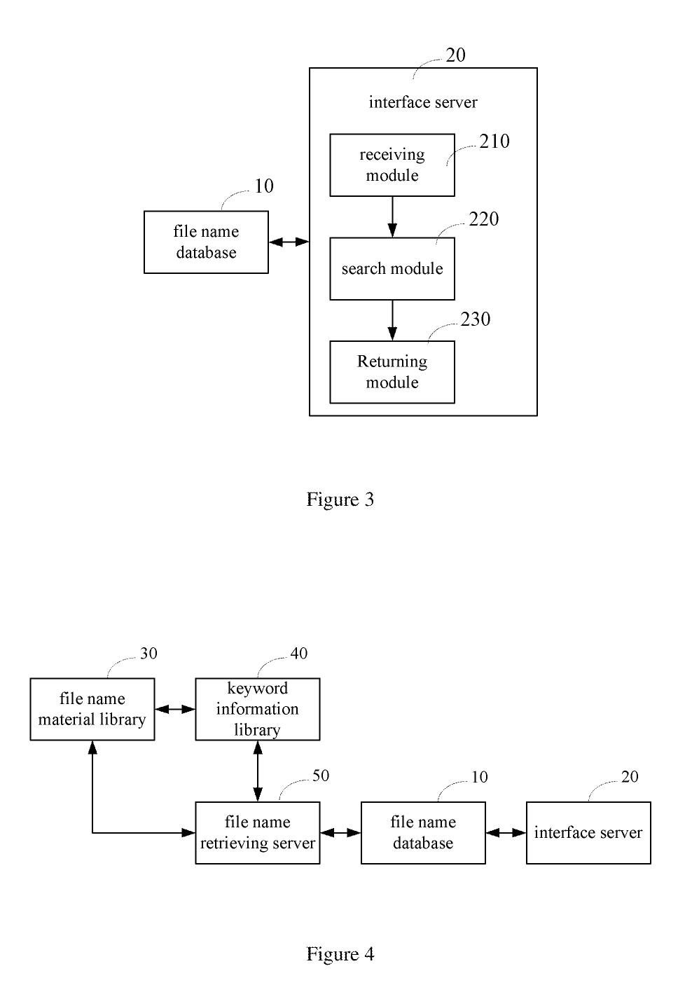

As shown in FIG. 3, a system for displaying a file name in an embodiment includes a file name database 10 and an interface server 20.

The file name database 10 is adapted to store a pre-established correspondence relationship between terminals' display dimensions and file name information.

The interface server 20 includes a receiving module 210, a search module 220 and a returning module 230.

The receiving module 210 is adapted to receive a check request for a file, where the check request includes the display dimension of a terminal.

Specifically, the display dimension of the terminal is referred to as the dimension of a User Interface (UI) of the terminal which mainly includes the height and the width of a display area. The terminal may be various devices required to display the file name, such as a portable media player, a desktop computer, a laptop computer, a PDA, a cell phone and etc.

The search module 220 is adapted to search the pre-established correspondence relationship between terminals' display dimensions and file name information stored in the file name database 10 for the file name information corresponding to the obtained display dimension of the terminal.

Specifically, adopting the pre-established correspondence relationship between terminals' display dimension and file name information stored in the file name database, the corresponding file name information may be obtained by searching the file name database 10 according to the obtained display dimension of the terminal.

The returning module 230 is adapted to return the file name information to the terminal and display the file name information on the terminal.

Specifically, when the searched-out file name information is returned to the terminal and displayed on the terminal, as the file name information is obtained according to the display dimension of the terminal, the file name information can be completely displayed on the terminal. In an embodiment, the receiving module 210 is further adapted to receive a check request for the complete file name information of a file, and the returning module 230 is further adapted to return the complete file name information of the file to the terminal. When a user desires to check the complete file name information of the file, the returning module 230 returns the complete file name information to the terminal.

As shown in FIG. 4, the system for displaying a file name in an embodiment includes a file name material library 30, a keyword information library 40 and a file name retrieving server 50 besides the file name database 10 and the interface server 20.

The file name material library 30 is adapted to store a string of an original file name.

In the embodiment, the file name of a file is mainly referred to as the file name of a multi-media file, and the string of the original file name of a multi-media file is obtained. The multi-media file may include files such as a movie, a TV play, a news video, a self-shot video and etc. The multi-media file may generally be an online video retrieved from a popular video website.

The string of the original file name is referred to as complete file name information. Taking a movie's file name information as an example, the file name information of the movie includes a movie title, file release source information, release version information, audio/video coding information, file format information, definition information and etc., such as “Captain.America.The.First.Avenger.2011.AmericanCaptain.BilingualSubtitle.HR-HDTV.AC3. 1024×576.×264-RenrenMovie&TVProduction.mkv”, where “Captain.America.The.First.Avenger” denotes the movie title, “2011” denotes the decade, “AmericanCaptain” denotes the Chinese title, “BilingualSubtitle” denotes the type of subtitles, “HR-HDTV” denotes the compression format, “AC3” denotes the audio format, “1024×576” denotes the resolution, “×264” denotes the compression technique, “RenrenMovie&TVProduction” denotes the producer, and “mkv” denotes the file format.

The keyword information library 40 is adapted to store keywords. In the embodiment, the keyword information library includes but not limited to a file publishing source dictionary library, a file format source dictionary library, a video and audio encoding format dictionary library, a release version dictionary library and a definition dictionary library etc. The keyword include a file publishing source keyword, a file format source keyword, a video and audio encoding format keyword, a release version keyword and a definition keyword etc.

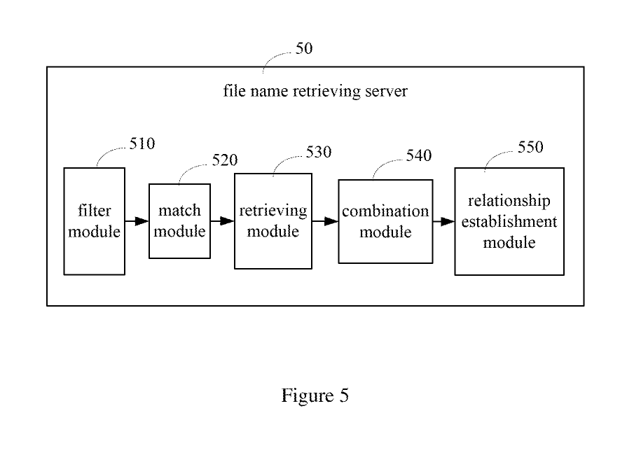

As shown in FIG. 5, the file name retrieving server 50 includes a filter module 510, a match module 520, a retrieving module 530, a combination module 540 and a relationship establishment module 550, where the filter module 510 is adapted to filter out useless characters in the string of the original file name in order to remove from the original file name the useless characters which have strong regularity. The useless characters mainly include the following three types:

(i) The first type of useless characters denotes a multi-media file is which part of a TV play, such as the second chapter of the seventh episode, the eighth dialog, the seventh scene, part A, part1, cd1, cd2, the first part, the last part and etc.

(ii) The second type of useless characters denotes some common description words including stop words or functional words, such as a Mandarin version, a Cantonese version, Chinese subtitles, an U.S. play, a Korean play, classics, hit, a love-story play, animation, horror, action, romance, comedy, long trailers, trailers, stories behind the scenes, stories and etc.

(iii) The third type of useless characters denotes meaningless characters or junk information such as a large number of certain junk fields e.g., premiere, exclusive premiere, the latest, watch online, the first exclusive online premiere, summer must-see, dubbing, TV and TV play as well as some junk characters and those with no content like ] [, [“&&”], “ [symbol] “&&” [symbol] ”, ( ), ( ), [ ] and etc.

The match module 520 is adapted to match the string of the original file name with a pre-established keyword information library to obtain keyword information.

In the embodiment, the keyword information library may be established in advance which includes but not limited to a file publishing source dictionary library, a file format source dictionary library, a video and audio encoding format dictionary library, a release version dictionary library and a definition dictionary library.

The match module 520 may adopt a string-based matching method in matching the string of the original file name with the keyword information library 40. Specifically, the match module 520 performs matching for the string of the original file name with useless characters being filtered out according to a maximum matching method. For example, the longest entry in the keyword information library has i characters, the first i characters in an array of the string of the original file name to be matched is taken as a match field; if there is a word with i characters in the keyword information library, it indicates a successful match, and then the match field is split from the string of the original file name as a word, and otherwise, if there is no such word with i characters in the keyword information library, it indicates a unsuccessful match, and then the last character of the match field is removed, the match word including remaining characters is used to be matched in the keyword information library again; the matching process is repeated as above until a successful match is got.

The retrieving module 530 is adapted to retrieve the file name from the string of the original file name according to a regular expression rule.

Specifically, a regular expression is referred to as a single string for describing or matching with a series of strings in accordance with a certain syntactic rule. Through retrieving the file name according to the regular expression rule, a part of the string of the original file name which is matched with the regular expression rule can be replaced by a predefined character such as a blank space, an underscore or etc. An example of the regular expression rule is as shown in Table 1.

The combination module 540 is adapted to combine the file name and the keyword information to form the file name information of a different length.

Specifically, any combination of the file name and the keyword information may form the file name information. For example, a piece of file name information may be formed by any combination of source codes, the mkv format and a resolution of 1024×576.

The relationship establishment module 550 is adapted to establish the correspondence relationship between the terminal's display dimension and the file name information and store the correspondence relationship in the file name database.

Specifically, the file name information with a different length may be matched with the terminal's display dimension, the pre-established correspondence relationship between the terminal's display dimension and the file name information can guarantee that the whole file name information can be displayed on the terminal. After the correspondence relationship between the terminal's display dimension and the file name information is established, it is stored in the file name database 10, so that when a terminal requests of displaying the file name information, the file name information corresponding to the terminal's display dimension is searched out.

According to the above method and system for displaying the file name, the correspondence relationship between terminals' display dimensions and file name information is established in advance, the corresponding file name information is found according to the obtained display dimension of the terminal and is returned and displayed on the terminal, so that it can be realized that the file name information with a fit length to be displayed on the terminal is found through matching according to various display dimensions of terminals, and it is convenient for the user to check the file name information.

In addition, the keyword information is derived from the string of the original file name through matching the string of the original file name in the keyword information library, the file name is retrieved from the string of the original file name, the file name information with various lengths can be formed according to the file name and the keyword information, and then the correspondence relationship between terminals' display dimensions and the file name information can be established. The whole procedure is accomplished automatically without large amounts of manual collection and selection, thereby reducing labor costs and leading to convenient operations. The step of filtering the useless characters from the string of the original file name further provides accuracy of the matched keyword information and shortens the period of the matching process.

Furthermore, the present invention provides one or more computer storage mediums including computer-executable instructions which are adapted to perform the method for displaying the file name. The specific steps by which the computer-executable instructions in the computer storage medium perform the method for displaying the file name are the same as the above description of the method and will not be discussed again herein.

The above embodiments are just several embodiments of the present invention, the description of which is relatively specific and detailed and cannot be regarded as limitation to the scope of the present invention. It should be noted that for those skilled in this art any modification and improvement without departure from the idea of the present invention are within the protection scope of the present invention. Therefore, the protection scope of the present invention should be subject to the claims attached herein.

1. A method for displaying a file name, comprising the following steps:
receiving a check request for a file, the check request comprising display dimension of a terminal;
searching file name information corresponding to the display dimension of the terminal in a pre-established correspondence relationship between display dimensions of terminals and file name information; and
returning the file name information searched out to the terminal and displaying the file name information searched out on the terminal;
wherein the method further comprises a step of pre-establishing the correspondence relationship between display dimensions of terminals and file name information;
the step of pre-establishing the correspondence relationship between display dimensions of terminals and file name information comprises steps of:
obtaining a string of an original file name;
obtaining keyword information by matching the string of the original file name with a pre-established keyword information library;
retrieving a file name from the string of the original file name according to a regular expression rule;
combining the file name retrieved and the keyword information to form file name information with various lengths; and
establishing the correspondence relationship between the display dimensions of the terminals and the file name information with various lengths.

2. (canceled)

3. The method for displaying the file name of claim 1, wherein before the step of obtaining keyword information by matching the string of the original file name with a pre-established keyword information library, the method further comprises a step of filtering out useless characters from the string of the original file name.

4. The method for displaying the file name of claim 1, wherein the keyword information library comprises a file publishing source dictionary library, a file format source dictionary library, a video and audio encoding format dictionary library, a release version dictionary library and a definition dictionary library.

5. The method for displaying the file name of claim 1, wherein the method further comprises a step of receiving a check request for the complete file name information of a file and returning the complete file name information of the file to the terminal.

6. A system for displaying a file name, comprising:
a file name database, adapted to store a pre-established correspondence relationship between display dimensions of terminals and file name information; and
an interface server, comprising:
a receiving module, adapted to receive a check request for a file, the check request comprising the display dimension of a terminal; a
a search module, adapted to search the file name information corresponding to the display dimension of the terminal in the pre-established correspondence relationship between the display dimensions of terminals and file name information stored in the file name database; and
a returning module, adapted to return the file name information searched out to the terminal and display the file name information searched out on the terminal;
wherein the system further comprises:
a file name material library, adapted to store the string of the original file name;
a keyword information library, adapted to store keywords; and
a file name retrieving server, comprising:
a match module, adapted to obtain keyword information by matching the string of the original file name with the keyword information library;
a retrieving module, adapted to retrieve a file name from the string of the original file name according to a regular expression rule;
a combination module, adapted to combine the file name retrieved and the keyword information to form file name information with various lengths; and
a relationship establishment module, adapted to establish the correspondence relationship between the display dimensions of the terminals and the file name information with various lengths, and store the correspondence relationship in the file name database.

7. (canceled)

8. The system for displaying the file name of claim 6, wherein the file name retrieving server further comprises a filter module, adapted to filter out useless characters from the string of the original file name.

9. The system for displaying the file name of claim 6, wherein the keyword information library comprises a file publishing source dictionary library, a file format source dictionary library, a video and audio encoding format dictionary library, a release version dictionary library and a definition dictionary library.

10. The system for displaying the file name of claim 6, wherein the receiving module is further adapted to receive a check request for the complete file name information of a file, and the returning module is further adapted to return the complete file name information of the file to the terminal.

11. One or more computer storage mediums comprising computer-executable instructions, the computer-executable instructions are adapted to perform a method for displaying a file name, the method comprising the following steps:
receiving a check request for a file, the check request comprising display dimension of a terminal;
searching file name information corresponding to the display dimension of the terminal in a pre-established correspondence relationship between display dimensions of terminals and file name information; and
returning the file name information searched out to the terminal and displaying the file name information searched out on the terminal;
wherein the method further comprises a step of pre-establishing the correspondence relationship between display dimensions of terminals and file name information;
the step of pre-establishing the correspondence relationship between display dimensions of terminals and file name information comprises steps of:
obtaining a string of an original file name;
obtaining keyword information by matching the string of the original file name with a pre-established keyword information library;
retrieving a file name from the string of the original file name according to a regular expression rule;
combining the file name retrieved and the keyword information to form file name information with various lengths; and
establishing the correspondence relationship between the display dimensions of the terminals and the file name information with various lengths.

12. (canceled)

13. The one or more computer storage mediums of claim 11, wherein before the step of obtaining keyword information by matching the string of the original file name with a pre-established keyword information library, the method further comprises a step of filtering out useless characters from the string of the original file name.

14. The one or more computer storage mediums of claim 11, wherein the keyword information library comprises a file publishing source dictionary library, a file format source dictionary library, a video and audio encoding format dictionary library, a release version dictionary library and a definition dictionary library.

15. The one or more computer storage mediums of claim 11, wherein the method further comprises a step of receiving a check request for the complete file name information of a file and returning the complete file name information of the file to the terminal.
